(19) United States
(12) Patent Application Publication
(10) Pub. No.: US 2026/0203518 A1
(43) Pub. Date: Jul. 16, 2026

(54) VIVA ANALYSIS: AUTOMATED ALGORITHMS TO ANALYZE DISAMBIGUATED NATURAL LANGUAGE (NL) TEXT TO DERIVE DEEPER UNDERSTANDING OF INTENT

(71) Applicant: EMPATHI Al INC., Joplin, MO (US)

(72) Inventor: Joseph C. Roushar, Joplin, MO (US)

(21) Appl. No.: 19/535,502

(22) Filed: Feb. 10, 2026

Related U.S. Application Data
(63) Continuation-in-part of application No. 19/214,139, filed on May 21, 2025.
(60) Provisional application No. 63/714,627, filed on Oct. 31, 2024.

(51) Int. Cl. G06F 40/30; G06F 40/284

(52) U.S. Cl. CPC G06F 40/30; G06F 40/284

(57) ABSTRACT

Mechanisms are provided for automatically determining a speaker or writer's viewpoint, intensity, veracity and intended audience of natural language text. Language understanding functions including question answering, information search and retrieval, text generation, machine translation, transcription, summarization and decision-support are more accurate when these indirectly articulated elements of intent are understood. The functions use explicitly coded and curated commonsense knowledge propositions that form a knowledge graph data structure to interpret these elements of intent using contextual, subtextual and extratextual cues. These mechanisms operate on input text that has already undergone lexical disambiguation and provide a framework for identifying bias, deception and literary devices including simile, metaphor, analogy, allegory, personification, hyperbole, metonymy, sarcasm, diplomacy, intimidation and allusion.

### RELATED APPLICATIONS

This application is a continuation-in-part of U.S. Non-Provisional application Ser. No. 19/214,139, filed May 21, 2025; which claims the benefit of U.S. Provisional Application No. 63/714,627, filed Oct. 31, 2024; the entirety of which are incorporated herein by reference.

### BACKGROUND

The present application relates generally to improved natural language processing (NLP) using cognitive Artificial Intelligence (AI) and more specifically to mechanisms for deeply understanding the original intent of a speaker or writer.

NLP and AI are broadly used in interpreting and translating spoken and written text to improve the results of question answering, information search and retrieval, text generation, machine translation, transcription, summarization and decision-support. The techniques, data and processes described herein are designed to improve the quality of the results over other approaches currently in use.

Examples of NLP/AI systems include neural-network systems such as Gemini from Google™, ChatGPT from OpenAI™ and Claude from Anthropic™, as well as cognitive systems such as IBM Watson™.

### SUMMARY

The following four separate types of analysis are used to automatically improve the interpretation and translation of natural language text. Once a meaning-based interpreter has resolved the lexical ambiguity in a speaker's utterance or writer's text, these deeper analyses based on an explicit commonsense data model will improve the quality of dialog and translation by identifying more of the speaker/writer's intent such as teaching, creating amusement, expressing emotion or drawing attention, and more closely approximate human ability to understand meaning in communication.

TABLE 1
Core VIVA Analyses

Viewpoint (including bias),
Intensity (including exaggeration),
Veracity (including agenda),
Audience (including social proximity).

In some embodiments these analyses are performed sequentially and in others, they are performed in parallel or interleaved.

### BRIEF DESCRIPTION OF THE DRAWINGS

The invention, its components and functions and their interactions will best be understood by reference to the following description of the illustrated embodiments when read in conjunction with the associated drawings. The sequential flow diagrams are not marked with beginning or end steps, but the direction of the arrows indicates sequence, and many of these processes operate in parallel with one another.

FIG. 1 depicts a schematic diagram of one illustrated embodiment of a deep intent analyzer system running on networked computing devices;

FIG. 2 shows several examples of the many different possible sources of training data that can be used in some embodiments;

FIG. 3 shows an embodiment of the core processing engine surrounded by local knowledge sources composed of context frames, attributes and candidates;

FIG. 4 shows embodiments of three views of the knowledge graph, its nodes and their interconnections.

FIG. 5 is an embodiment of the sequential learning process used to both pre-train and update the knowledge graph;

FIG. 6 is an embodiment of the sequential steps of Viewpoint analysis with indirect language detection;

FIG. 7 is one illustrated embodiment of arcs or spectra of bias across several topics, some of which intersect one another;

FIG. 8 is a structure and process diagram of the opinion and sentiment classifier for bias in viewpoint analysis;

FIG. 9 is one illustrated embodiment of the steps used in finding and marking figurative speech and verbal dissonances;

FIG. 10 is an illustrated embodiment of a sequential process flow for automatically determining intensity and hyperbole in text;

FIG. 11 shows one embodiment of a sequential process flow to analyze the input veracity and the speaker or writer's agenda;

FIG. 12 is an illustrated embodiment of a sequential process flow to characterize the audience and their social proximity;

FIG. 13 shows one embodiment of the overall flow for genetic algorithms used in the VIVA Analysis processes;

FIG. 14 illustrates the emergence curve of an individual candidate in an attribute;

FIG. 15 illustrates the emergence formulas for candidates and the aggregate solution fitness determination and validation.

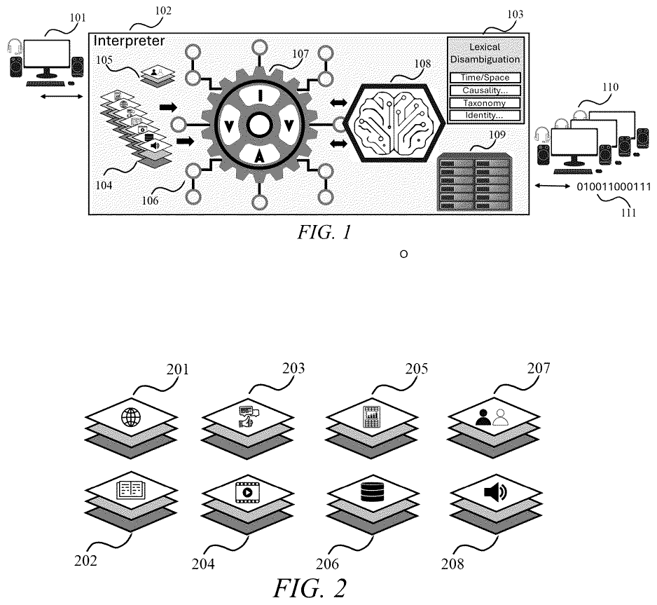

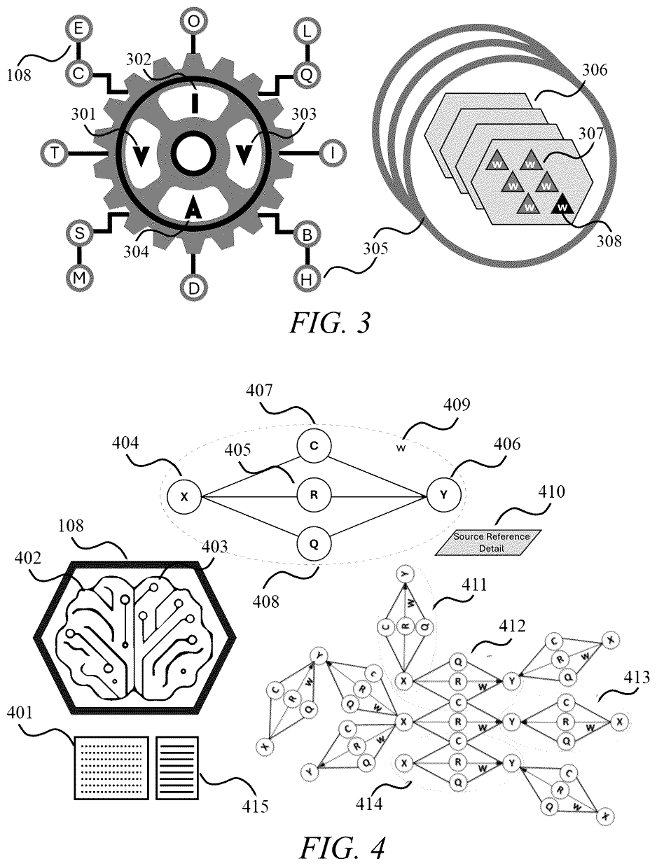

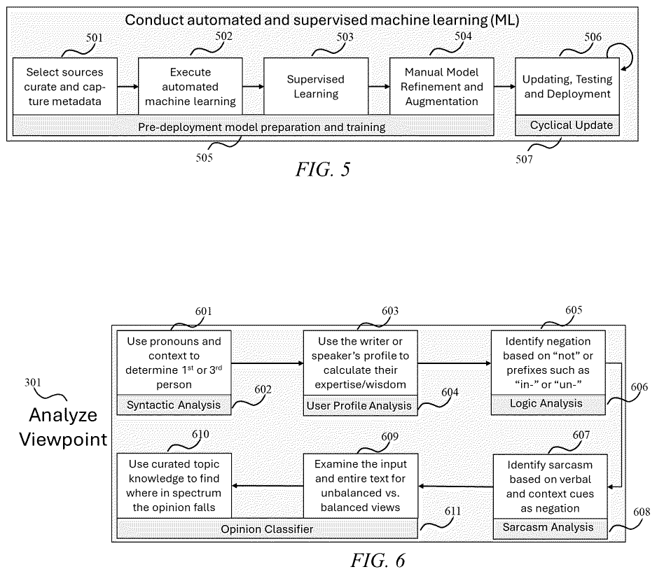

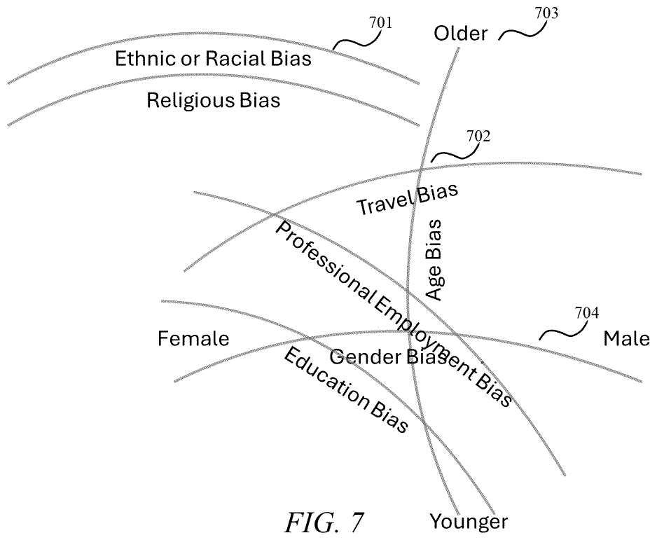

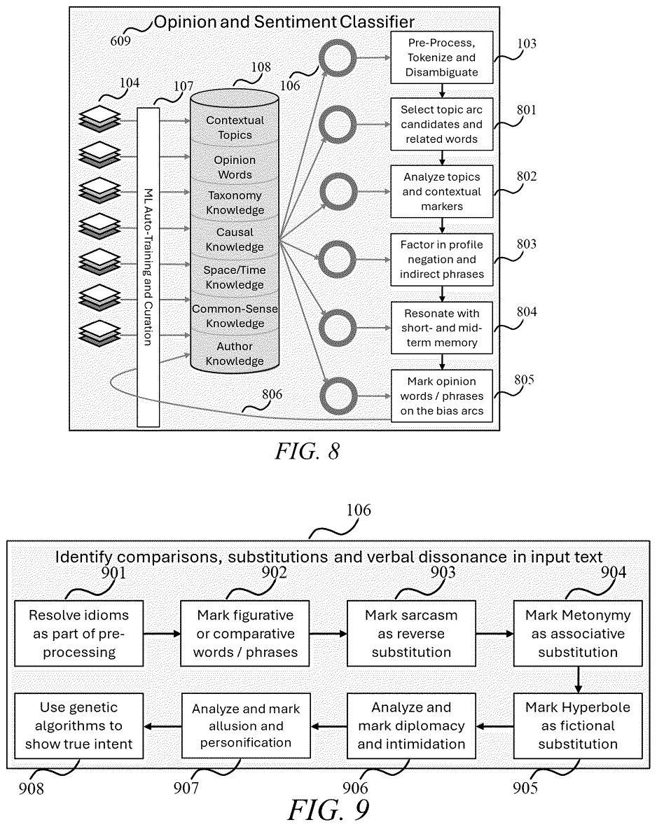

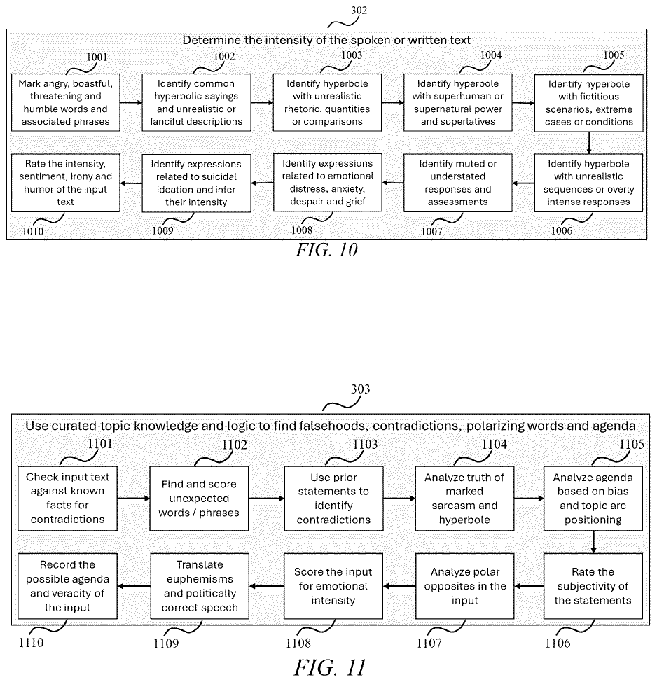

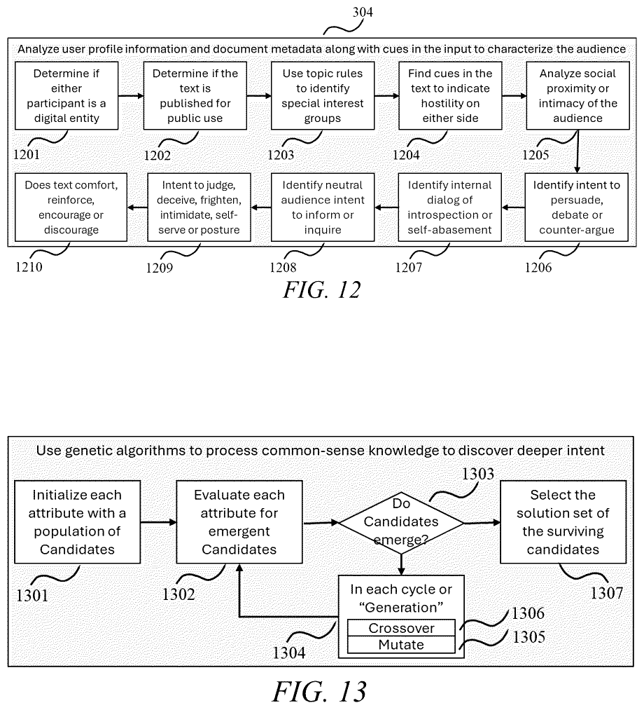

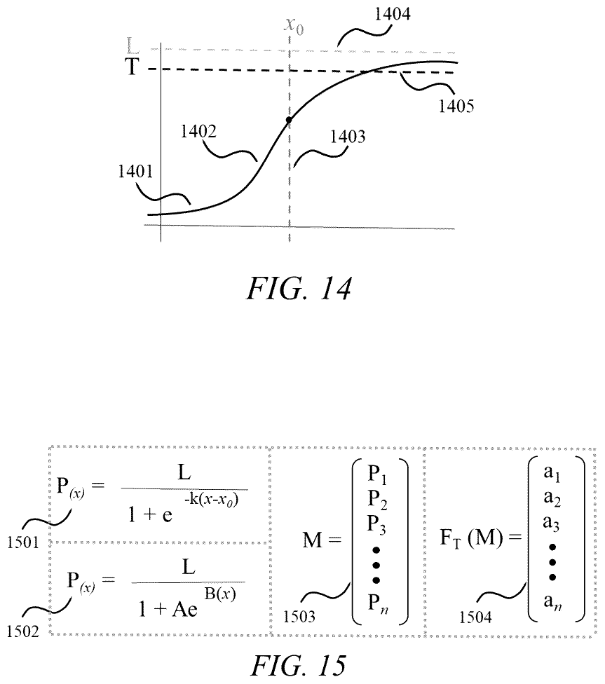

### DETAILED DESCRIPTION

The illustrated embodiments describe mechanisms for deep NL understanding that goes beyond the superficial meaning of the words and phrases to find nuance, subtextual and extratextual factors that could improve understanding of the input.

Indirect language is often used to convey fact, fiction or opinion. The difference between forms is that direct language attempts to unambiguously state the intended meaning while indirect language uses literary or rhetorical devices of comparison, substitution or reference to obliquely guide the audience to the intended meaning. For some listeners and readers, indirect language creates dissonance between the words' normal meanings and their intended meanings. This verbal dissonance affects computers more heavily than humans.

There are several forms of indirect language (see Table 2) germane to this work:

TABLE 2
Indirect language Forms

| FORM | CATEGORY |
|---|---|
| Simile | Figurative or |
| | Comparative |
| Metaphor | Figurative or |
| | Comparative |
| Analogy | Figurative or |
| | Comparative |
| Allegory | Figurative or |
| | Comparative |
| Personification | Fictional Substitution |
| Hyperbole | Fictional Substitution |
| (Hype) | |
| Metonymy | Associative |
| | Substitution |
| Sarcasm | Reverse Substitution |
| Diplomacy | Softening Language |
| Intimidation | Hardening Language |
| Allusion | Factual Reference |
| idiom | Common |
| | Colloquialism |

Because idioms generally have a shared meaning that is unambiguous to most audiences, they are processed in a manner similar to “Common Phrases” in the early stages of Lexical Disambiguation. 103 As an example, the Chinese hyperbolic idiom [symbol] (“There is no truth in your mouth”) is so common as to be unambiguous.

As body language is unavailable in non-video digital content determining VIVA-related factors that affect interpretation and translation is more difficult, but often possible using techniques that go beyond typical sentiment analysis and opinion mining. The contextual cues and hints become critical and require advanced analysis to delve greater depths of meaning. This patent describes automated techniques for working with largely disambiguated input text (the subject of prior Empathi AI patents) to infer deep meaning, metaphor, multiple meanings and negative or nefarious intent.

VIVA analysis is used in the automated and supervised Machine Learning (ML) processes as well as real-time interpretation and translation of NL text. In ML, VIVA can help identify and define opinion arcs that serve as spectra for future analysis and assignment of position tags that show where on a spectrum of opinion the NL text seems to fit most comfortably.

Many writings and utterances may encompass multiple topic areas and can be positioned on multiple spectra. The T-shirt that proclaimed “Nuke the gay whales” is such an example, spanning multiple popular causes in a short sentence exposing several biases.

System administrators manage the NL Interpreter software from a workstation 101 with access to the Interpreter 102 including lexical disambiguation capabilities 103 (see prior patents). Both pretraining and real-time learning from multiple diverse sources 104 leverage the VIVA-enhanced Interpreter services to improve the outcomes of ML. Learning is augmented by manual curation and human input capabilities 105.

The VIVA Analysis process uses local memory for staging portions of the model 106. The cognitive AI services 107 use Bayes Classifiers supported by genetic algorithms to both train and query the knowledge model 108 and all components are coded as services with APIs running on back-end servers 109. Whether using AI for search and retrieval, question answering or translating, users access the system through a workstation 110, laptop, tablet, mobile device, automobile, refrigerator door or any other digital device from which they provide text to interpret 111.

ML includes pretraining and real-time learning from multiple diverse sources 104 that are expanded in FIG. 2 to characterize some of the most popular sources for accumulating needed knowledge. Web pages 201, books 202, social media posts and comment threads 203, rich media such as video content 204, semi-structured data such as spreadsheets 205, structured data such as databases 206, direct input from human knowledge sources 207 and audio data 208 are some of the training ML sources.

Because the system can understand text from all these sources 104 on first read using the cognitive techniques described herein and in the prior patents referenced, each source is processed only once. Because of the use of human curators 105 and knowledge contributors 207, the knowledge model contains nuanced concepts that describe the same ideas that humans use to delve beneath the superficial words they hear and read to understand subtext and unspoken meaning. Human experts can also create and modify knowledge propositions that differentiate between normative and non-normative concepts and behaviors and well-established facts vs. falsehoods and hearsay.

There are many ways language is used to convey meaning beyond the words. The VIVA process analyzes some of these communication phenomena by analyzing the speaker or writer's viewpoint 301 including biases, the intensity 302 of the communicated words including hyperbole, the veracity 303 of the communication and the intended audience 304 including analysis to determine the social proximity between the parties to communication.

In some embodiments context frames 305 may include time, space, taxonomy, causality, bias and other contextual containers for attributes 306. Each attribute is designed to answer an important question about the input 111. As examples, in the time context there are attributes such as event duration, event start time, event end time and time of day. Context frames 305 are analogous to populations, attributes 306 are analogous to gene pools and candidates 307-308 are analogous to generations in genetic algorithms with “w” the weight serving as the fitness measure.

VIVA Analysis leverages all types of knowledge propositions imported from the knowledge graph 108 to local memory 106 to populate the contextually 305 segregated attributes 306 with candidates 307.

The candidates 307 are the possible answers to the questions of the attributes 306. Each candidate 307 is assigned to one or more attributes 306 and one or more candidates may emerge 308 as a survivor. The “survivor” is a metaphor for the “fittest” or best candidate 308 based on weight that emerges as the best answer to the question of the attribute 306.

Rather than going back to the larger knowledge network for each separate analysis process, salient knowledge propositions are extracted from the large model 108 and stored in many local memory 106 locations optimized for the algorithms. Each local memory location 305 represents a context which groups elements of meaning needed to understand the input 111 to be analyzed separately:

E = Events − Related to Causality
C = Causality including mechanisms
T = Time and duration
S = Space and location
M = Motion combining time and space
D = Diction: choice of words and phrases
H = Honesty including agenda
B = Bias, opinion and sentiment arcs
I = Identity of people involved
Q = Quantities and comparisons
L = Logic, inclusion and exclusion
O = Objects and their taxonomies

The explicit knowledge model 108 includes a metadata store of source details 401 and a knowledge graph to support the cognitive processes. It is a network 402 of millions of nodes, each of which is a weighted knowledge proposition 403 of the format X-R-Y-C-Q. The X object 404 is a word, symbol or short phrase representing meaning. As words, symbols and phrases are ambiguous, one X object 404 may be part of many knowledge propositions.

Each knowledge proposition describes how X 404 Relates 405 to another object Y 406. This relationship is ascribed to a specific context C 407 in which the relationship R 405 applies. A Q object 408 qualifies the relationship with some meaningful constraint and the entire proposition is given a weight W 409 which is a confidence value that supports “fuzzy reasoning”.

In short, each knowledge proposition states that: within the context of C 407, object X 404 is Related 405 to object Y 406 with a qualifier of Q 408 with a probability of w 409. The underlying premise is that anything that can be known can be expressed using this formula, hence the lexical disambiguation 103 process and the VIVA Analysis processes can combine to use this knowledge base to fully understand a speaker or writer's intent. A node is alternately called a “knowledge molecule” and its components, other than the weight are called “atoms”.

In order to validate knowledge acquired through automated ML processes the system stores metadata about the sources 410 for future learning and to provide source information to users when requested.

Each node 403 in the network 402 is logically connected to any other node in the network by one or more object atoms whose values match exactly. Nodes may be connected by the X atom 411, the C atom 412, the Y atom 413 or multiple atoms such as C and Y as shown in 412 and 414. Atoms are words or short phrases in the lexicon 415.

Once sources are selected and annotated 501 training the model uses automated ML 502 procedures and supervised or manual 503 knowledge acquisition. The automated procedures are similar to training Large Language Models (LLMs) using generative AI, but instead of ingesting each source document many times, each is read once. This efficiency not only increases ML speed but limits environmental damage by being orders of magnitude more efficient than generative AIs.

Both automated and manual procedures are used to refine and augment the model based on knowledge gap detection algorithms 504 as well as human curation providing expert annotations and manual training, and once these processes are complete, the model is moved from a pre-deployment ML state 505 to testing and deployment 506 in a post-deployment continuous learning state 507.

Many of the core VIVA Analysis processes use a Native Bayes classifier with genetic algorithms for solution candidate population thinning and differentiation. The genetic algorithms use heuristics tailored to each context to use fuzzy reasoning about confidence values to select the most likely meaning of each input 111 word and the most likely interpretations of the viewpoint, intensity, veracity and audience. This will be described later.

Viewpoint Analysis: A speaker's or writer's viewpoint 301 has a profound impact on interpretation and translation. Especially in modern parlance, sarcasm, irony and reverse idioms are abundant. “That's wicked” used to bespeak displeasure and evil while it now commonly reflects approval, acceptability and good. In order to determine which, many contextual cues are needed.

As with other elements of this analysis identifying viewpoint and bias often involves subtextual or extratextual information not included in the input 111. Viewpoint 301 requires several analyses:
Determine the communication 1^{st} person vs. 3^{rd} person perspective 601 as part of syntactic analysis 602;
Determine the person's knowledge or expertise in the topic based on their life, education and work experiences 603 to build the user profile 604;
Identify reversals based on direct negation using words such as “not” and prefixes such as “un-” and “in-” 605 as part of logic analysis 606;
Identify probable sarcasm or indirect negation using verbal and contextual cues 607 for sarcasm analysis 608; and
Determine bias or imbalance favoring one side of an issue over another 609 as reflected in the meaning of the communicated words to locate the opinion on a given topic's spectrum 610 using opinion analysis 611.

Differentiating between first person and third person NL text 601 is important in understanding intent. The cues and markers that serve this analysis are shown in Table 3.

TABLE 3
1^{st} Person vs. 3^{rd} Person Viewpoint

| | |
|---|---|
| | THIRD-PERSON (AND |
| FIRST-PERSON | OMNISCIENT) |
| PERSPECTIVE | PERSPECTIVE |

Pronouns

| | |
|---|---|
| I,” “me,” “my,” “we,” “us,” “our” | “He,” “she,” “it,” “they,” “them” |

Narrative

| | |
|---|---|
| A story is told by a character in | The story is told by an outside |
| a story to create an intimate | narrator who is not a character |
| connection with readers. | in the story. |

Information

| | |
|---|---|
| Limited to what the narrator | Can be limited to one |
| knows, thinks, and experiences. | character's thoughts (third- |
| | person limited) or can know |
| | everything about all |
| | characters and events |
| | (omniscient). |

Example

| | |
|---|---|
| “I think this is a bad idea,” she | “That is a bad idea,” she said, |
| said, wringing her hands. | wringing her hands. |

The subject ML system can learn from the pronouns, the narrative, the information and the examples to accurately differentiate between first person and third person text. Then using that knowledge and the genetic algorithms, can classify input text 111 as first person, third person or omniscient viewpoint using syntactic analysis 602 techniques.

The personal pronouns “I,” “me,” “my,” “we,” “us,” “our” imply the participation of a “self” and an “other” in an utterance or piece of writing. As this is a complex topic, especially when one of the “selves” in a dialog is a digital entity, this will be addressed more fully in the process of analyzing “Audience” 304. In this Viewpoint 301 analysis, the point of pronoun analysis is to identify the possessor of the Viewpoint.

User profiles 603 can be stored in a database on the server 109 or can be built in real-time during the interpretation and VIVA analysis processes. This user profile analysis 604 function is most useful when the speaker or writer is well-known with public information available that can be ingested as part of ML pre-training.

In some embodiments user profile analysis 604 can be expanded to perform character development analysis for historical or fictional texts in which a character's typical behavior at different points in the story changes as the character's attitudes or motivations change over time. In such cases, a character's words and intent at an earlier point in the narrative may profoundly differ from the same character's words and intent later in the narrative. It is often the character changes over time that make a story worth retelling.

Recognizing negation words and prefixes 605 as well as AND/OR/Exclusive OR logic 606 is also straightforward, and it is critical in understanding the viewpoint of the speaker or writer.

Sarcasm 607 or mockery is one of the more difficult things to detect for computers and often for humans. Sarcasm is a form of contradiction in which the words contradict the true feelings of the speaker or writer.

The sarcasm analyzer 608 uses a collection of known sarcastic words that display sentiment shifts in specific context. The analyzer identifies an objective word and uses the Bayes Classifier to identify whether the objective word is used in a direct or satirical sense.

The objective word functions as a pivot point in a person's feelings, observation or intent towards a thing or activity such as people, institutions, activities, current events, or ideas. The person's words could reflect a positive or negative 607 viewpoint and identifying the cues for the analyzer 608 to calculate a snide score to determine the true intent relies on large amounts of context.

Human listeners use body language, facial expressions, tone or shared knowledge to detect sarcasm, but NLP models must infer intent from text and contextual cues. For instance, the sentence “I love walking up 6 flights of stairs for a 5 AM meeting” might be sarcastic, but an AI could incorrectly mark it positive missing the frustration implied by the possible unpleasantness of the scenario. Paired with video analysis this system can be even stronger.

Contextual cues may be extratextual as in the case of a favorable statement about traffic, especially during a time of day and at a location where traffic patterns are typically not pleasant. Large amounts of common-sense knowledge are required to make these associations. This system is designed to gather, store and process large amounts of common-sense knowledge that can be used for this purpose. (See paragraphs [0032] to [0034] for explanation of the molecular structure of knowledge propositions.)

TABLE 4
Sample Knowledge Propositions

| X | R | Y | C | Q | W |
|---|---|---|---|---|---|
| traffic jam | condition | crowdedness | driving | slow | 6 |
| traffic jam | result | rush hour | transportation | urban | 6 |
| traffic jam | cause | frustration | drivers | late | 6 |

Sarcasm analysis 608 includes a forensic function using common-sense knowledge that seeks evidence supporting an assertion in the input 111 or evidence refuting it. With a sufficiently large training data set and good quality human curation with expert annotation and input, the system will gradually improve its ability to detect and respond appropriately to sarcasm and other indirect communication patterns.

Perhaps the most important part of viewpoint 301 in disambiguating NL input is bias. Bias in communication is often not apparent, and even intelligent listeners may miss nuances of things people say and write. Using AI to find such subjective factors requires context—the more the better. Balance analysis 609 uses the topic arcs to identify balanced exposition of the text or more opinionated exposition. Finding well-balanced information is rare and becoming more so as special interest groups use mass media to influence opinion. The analysis is called opinion classification 611.

Bias can be explicit as often seen in discriminatory language targeting political, social, religious, racial or ethnic groups targeted in social media. Implicit bias subtly perpetuates prejudice through selecting un-curated data in machine learning and unintentional language use but can be equally harmful. As an example, religious opinions can run a spectrum from fervent belief to adamant denial in a supreme being and/or a specific religious tradition.

This system uses curated topic knowledge describing a spectrum for each known topic of possible opinions that represent explicit and implicit biases for or against possible understanding of the issues. This has been described using the concept of polarity, but analog spectra provide richer, more specific pinpoints when enough information is present.

While some work is being done on generalized bias detectors, this may not be possible in some domains. Race, age and gender bias may lend themselves to generalized approaches, but other topics may require more tailored, curated approaches to flag the terms and expressions that imply bias and where on a spectrum that bias falls.

Contextual cues such as charged words and phrases in both the input text phrases and sentences and the speaker or writer's profile provide hints in each area that can be analyzed automatically to deepen understanding and inform the user of the subjective positioning of the evaluated text.

“Emotionally charged” language is characterized by specific words or phrases that are disproportionately associated with certain demographic groups, such as genders or races. For example, certain adjectives might be used more frequently in describing women than men, or vice versa.

We build topical spectra 610 using Contrastive Learning, training the model by comparing data points, aligning similar pairs (positive pairs) and separating dissimilar pairs (negative pairs) along each defined spectrum. The learning algorithm creates a model similar to a skip-gram neural model, but in explicit knowledge propositions thus enabling multiple intersecting spectra encodings for conceptual objects that span multiple topics or contexts.

Each arc or spectrum topic 701 is named and knowledge propositions make reference to a named topic. Often statements can appear on more than one arc or spectrum of bias if they intersect such as “age bias” and “travel bias” 702. The illustration shows only a very few of the thousands of the existing topic arcs and names the end points of fewer. In the “age bias” arc the endpoints are Younger and Older 703. The endpoints of “Gender Bias” are Male and Female 704.

An arc that has significant overlap with the “Gender Bias” arc is the “Gender Dysphoria” arc which is also the subject of significant bias, but it is an arc for which endpoints are much more difficult to define and it is characterized more by clusters of opinion. Clusters can also be tagged meaningfully to show where the opinion is situated compared to other opinions.

Example knowledge propositions are shown in Table 5.

TABLE 5
Sample Bias Knowledge Molecules

| X | R | Y | C | Q | W |
|---|---|---|---|---|---|
| racism | type | bias | society | ethnic | 6 |
| ageism | type | bias | society | favors youth | 6 |
| ableism | type | bias | society | scorns | 6 |
| | | | | disabilities | |
| skin color | trigger | discrimination | racism | prejudicial | 6 |
| male dominance | instance | attitude | gender bias | chauvinistic | 6 |
| conservatism | instance | bias | politics | right-wing | 5 |
| liberalism | instance | bias | politics | left-wing | 5 |
| pacificism | type | bias | conflict | peace-loving | 5 |

There is much literature about age bias, gender bias and ethnic or racial bias. There is much less literature about the thousands of other topics for which biases exist. Therefor the learning process must be extremely fine-tuned and human curators provide significant value in defining the arcs and placing specific attitudes and opinions at various points along the arcs.

There are very few topics for which there is no variance in perspective. Some of the major biases, as shown below, affect people's views of a near infinite variety of topics. Some major bias arcs are areas where modern AI solutions have reflected human biases including those shown in Table 6:

TABLE 6
Common Topics of Biased Text

Gender bias (Sexism)
Employment bias
Regional and national bias
Ethnic bias
Age bias
Ability/Disability bias (Ableism)
Education bias
Economic status (prosperity) bias
Political bias
Religious bias
Health bias (physical and mental)
Bias toward one side of a conflict
Personal tastes, likes and dislikes
Localized biases

Aikokushin ( [symbol] ) is the Japanese word for patriotism or love and loyalty for one's country. Aikyoushin ( [symbol] ) is a more local or hometown loyalty and can apply to the place, its people or athletic teams or the natural topographic features that make the place unique. These feelings are ubiquitous in human societies and one's own nurturing can affect many biases.

Common-sense knowledge was often described as “Compiled Knowledge” in the context of Expert System engineering because, while everyone possesses it, few people can easily articulate it. Cognitive systems such as the present invention rely heavily on the availability and quality of commonsense knowledge about the full range of possible topics to be processed.

The process to identify bias in input text begins with the learning process in which selected and curated sources 104 are fed into an automated ML process 107 to train the knowledge base 108. The interpreter 102 performs lexical disambiguation 103 before running the Viewpoint analyses 601-610.

The opinion classifier 609-611 is the final step in Viewpoint 301 analysis. The topics of the input text 111 are identified and words related to each topic are selected 801. For selected words, the contextual markers 802 are also selected for use in the resonance process. In preparation for resonance, negation and identified indirect language are marked 803 for special processing.

The resonance process 804 uses fuzzy reasoning in genetic algorithms to nudge each candidate solution for each attribute gradually toward or away from emergence by heating and cooling them based on corroborating or refuting evidence in the overall data set of input, contextual, subtextual and extratextual information.

The data set includes short-term information from the immediate sentence being interpreted, mid-term information from the sentences just prior to the current input, and, in some embodiments, forward looking information from subsequent sentences not yet fully processed.

The system always has access to long-term information stored in the knowledge model 108. There are many categories of knowledge but they are stored together in a knowledge graph. Knowledge of all types can contribute to resonance processes 804 that look at prior sentences in mid-term memory and, when possible, following sentences. The genetic algorithms use survival of the fittest or “Fitness Assessments” to identify and promote the best solution candidates.

Sentiment analysis is performed alongside opinion classification as they significantly overlap in both the process and the learned data they consume. Finally, the opinion words and phrases are marked with their relative position on the bias spectra or arcs 805 along with sentiment markers. A feedback loop 806 implements reinforcement learning to further train and tune the knowledge graph 108.

If requested, the Bias classifier provides a rationale or explanation for its classification decisions by showing the emergence process of each candidate in each attribute for which information was processed. In some embodiments, the opinion classifier will try to infer the source of the biases: bias from data, bias from annotations, bias from input representations, bias from models, bias from research design.

In parallel with viewpoint 301 and intensity 302 analyses, comparison, substitution and verbal dissonance analyses run to identify literary devices used to indirectly convey meaning. Idioms 901 are the one type of indirect communication resolved in the pre-processing 103 stage of the interpreter. Indirect language may be used to express quantitative or qualitative similarity and difference.

Figurative or comparative words and phrases 902 are analyzed for metaphors, analogies and allegories, and marked as elements of intent along with the true intended meaning 908 being substituted by the literary devices. VIVA analysis uses unexpected adjective-noun pairs as well as unexpected subject-predicate and verb-object relations. Some metaphors are hyperbolic as in “Time is money” is a metaphor in which “time” is the noumenon and “money” is the metaphoric object.

Onomatopoeia is a form of mimesis that is used metaphorically to create vivid imagery and emotional impact by connecting a word's sound to a non-linguistic sound. In some languages, this form of metaphorical language is important and present in everyday language. Training the system in the associations between mimetic words and their intended meanings is straightforward as there is much published literature from which to draw.

Similes are inherently unambiguous because they self-identify as comparisons, therefor require no extra analysis. Similes often use adjective-noun pairs such as “she's fast as a cheetah” or “he's tall as a giraffe” where metaphors often omit the adjective as in “she's a cheetah” or “he's a giraffe”. Some metaphors are simple comparisons as in “The rainbow looks like a bridge”.

Sarcasm 903 identified in the sarcasm analysis 607-608 is also marked as substitution so the actual feelings of the speaker or writer can be substituted back into the meaning or intent 908 solution of the input 111.

Metonymy is a device that uses an associated noun to reference the intended meaning. As examples: “Philadelphia may not make it to the Superbowl this year” actually refers to the football team, the Philadelphia Eagles, and “The White House is not confirming the rumor” actually refers to the staff of the President of the United States. Cities do not attend sporting events and buildings do not issue statements. But use of Metonymy 904 is a common shorthand used in communication, especially news forced to work within confined time and printed space limits. Actual meanings are inferred 904 and added to the intended meaning 908.

In parallel with intensity analysis 302 hyperbole exaggerates the actual meaning. Once analyzed and marked 905 the true meaning can be substituted back into the solution 908.

Human interactions are often politically correct, diplomatic, euphemistic or the opposite: threatening or insulting. Substituting softer or harder words for their underlying meaning requires large amounts of curated common-sense knowledge to discover and infer the true intent 906. The fuzzy reasoning in the genetic algorithms becomes more robust over time, especially with expert curation and augmentation.

Allusions 907 are becoming more and more challenging as the amount of digital content increases, dramatically growing the training source pool. The core interpreter uses a knowledge fabric that includes extensive source metadata, so finding source material that is well enough known to be alluded to is much easier than if the source data were fed into the ML process without metadata or annotations.

Personification 907 of inanimate objects is much easier to identify and find the intended meaning 908. In this process, the system identifies a non-living thing that is ascribed human characteristics, especially thoughts and feelings or other ascribed capabilities, and notes that the thoughts and feelings or capabilities are more important to understanding the intent of the input than the personification 907 of a non-living thing.

The resolution of these processes is to deliver the inferred actual intent 908 of the text to the user in the form defined by the application of the solution, whether for question answering, information search and retrieval, machine translation, transcription, text generation, summarization or decision-support.

The functioning of the genetic algorithms is described later in this section. The surviving population or emerging candidates are stored along with the input 111 and users are given the ability to see an explanation of the reasoning process and justification of the inferred meanings.

Intensity Analysis: The intensity analysis 302 includes an unsupervised classification process where we determine whether a phrase or sentence is hyperbolic or not. Semantic features we scrutinize for exaggeration broadly include: Quantity, Quality, Connotation, Emotion.

Exaggeration is often found in humor as well as ordinary day-to-day banter. Writers may also use humor as a literary device, often reflected in ironic or sarcastic statements, scenarios and descriptions.

The system evaluates both Intensity and exaggeration, 302 by comparing the content of utterances and writings with normative samples. To understand normative vs. extreme, the system learns commonsense knowledge across the full range of human experience. The factors above influence interpretation of intent and accuracy of translation. At a detail level, the Intensity Analyzer focuses on finding the semantic features and contextual cues in words and phrases vis-à-vis normative descriptions that express:
Intense and prolonged emotional reactions 1001
Extreme cases 1002
Comparison 1003
Rhetorics 1003
Quantity concepts 1003
Philosophical description about life 1003
Supernatural concepts 1004
Superlatives 1004
Fictitious scenarios 1005
Physical description of the state of body (sickness/health, size/strength) 1005
Description about nature (life/death, expansiveness/narrowness . . . ) 1005
Weather events 1005
Impossible sequencing of events (reversing cause and effect) 1006
Understated or muted descriptions that belie their true severity 1007
Excessive humility 1007
Emotional Distress 1008
Anxiety 1008
Grief and Despair 1008
Suicidal Ideation 1009
Common sayings 103

Example molecules in table 6 show superlatives including the suffix 'est applied to any adjective that could be either factual or hyperbolic.

TABLE 6
Hyperbolic knowledge samples

| X | R | Y | C | Q | W |
|---|---|---|---|---|---|
| biggest | instance | superlative | description | quantitative | 6 |
| best | instance | superlative | description | qualitative | 6 |
| [adjective] -est | instance | superlative | description | atypical | 4 |

By extracting knowledge propositions related to input 111 words and concepts from the knowledge graph 108 and placing them in local or staging memory 106 the system has the needed data to calculate hyperbolic versus realistic ranges and execute heuristic procedures to mark unrealistic descriptions.

Comparison knowledge propositions are typically marked by the presence of two associated phrases connected by the word “than” and used in another heuristic that marks similes or comparisons that are quantitatively or qualitatively unrealistic.

Veracity and Agenda Analysis 303: Some statements are scientifically false and can be shown to be incorrect by presenting a preponderance of evidence or enough evidence from trusted sources to sufficiently show a statement's incorrectness 1101.

The truthfulness of many utterances, however, may be difficult to ascertain digitally depending on the amount and quality of corroborating evidence. This may be particularly difficult in the case of topics in which both sides of the issue have strong supporting points, or where neither side of the issue has strong enough evidence to support their statements.

Likewise, a person's agenda may be concealed or clearly stated. In order to truly understand the intent, knowing or inferring the speaker's or writer's agenda can yield helpful insight. The system attempts to place where the utterance fits on the following possible arcs:
Arc of Self-serving to giving
Arc of kind to cruel
Arc of Judgmental to Accepting
Arc of Selling to exploring

Words or phrases may seem out of place in a dialog or multi-sentence text. The unexpectedness, based on contexts or causal factors that are unrelated to surrounding concepts, is scored 1102 and used to contribute to the veracity and agenda analyses.

Contradictions 1103 may appear within a single sentence, but they more commonly appear across multiple sentences of text (described in [0077-0078] as mid-term and forward-looking text).

While hyperbole may be used to exaggerate correct information, sarcasm is usually the exact opposite of the correct information. Both hyperbole and sarcasm may be used, however to draw attention away from the correct information and thus may be simple error or intentional deceit. This constitutes dual indirection and the knowledge and common-sense analyses described above can be used to identify 1104 such cases.

A speaker or writer's agenda 1105 may include intentional or unapologetic bias that can lead to unfair and often harmful favoritism or prejudice towards a particular group, person, or idea, which can be detected in profanity, unjustified criticism, or discriminatory language. Agenda analysis is completed as part of audience analysis 304.

Some philosophers have suggested that everything is subjective. A statement such as “The sky is blue” while being subjective is so widely repeated as to be very low on the spectrum of subjectivity. A statement such as “That music is annoying” may be rated as very subjective if, for example, the referenced music sells well or is high on popularity charts.

The subjectivity analysis 1106 feature uses knowledge acquired from consuming large amounts of digital content for comparison. As with other pre-trained AIs, the quality and quantity of training data will impact the effectiveness of this analysis.

Not only contradictions but reference to polar opposites 1107 in input text 111 can provide cues to infer the intended meaning of indirect language. In the presence of polar opposites in the sentence or multiple input sentences, heuristic analyzers can focus common-sense reasoning processes on the topic arc on which the polar opposites fit.

Emotional intensity analysis 1108 relies on processes similar to sentiment analysis in which words often used to express emotion including nouns like ‘happy”, “sad”, “angry”, “pleased” and “upset” especially associated with intensifying adjectives. These expressions are scored for intensity and contribute to the overall analysis of intent.

Euphemisms and politically correct speech are examples of indirect language meant to remove negative connotations or concepts to broadly appeal to the audience. Such expressions must be translated 1109 in order to capture the true intent behind the text and render proper interpretation and translation. Curated knowledge will identify euphemisms in common use. More advanced analysis incorporating multiple techniques 107 is needed to identify new or uncommon euphemisms.

The combination of all the preceding analyses 301, 302, 303 provides a foundation for inferring the possible agenda and veracity of the input 1110.

Audience and Social Proximity 304: Communication acts require two sides, the speaker or writer and the audience. In dialog, the roles shift back and forth. Either speaker in a dialog can compose language that somehow refers to their own perspectives which implies a “self” or an “I”. A sense of “self” is dependent upon an entity that can self-reference and a sense of another that can serve as a foil.

In a human-to-computer dialog, as in any human-to-human dialog and human-to-animal dialog the two selves in communication alternate roles between self and other as they alternate roles between language composer and language interpreter.

Understanding intent is completely different when a person is speaking to their AI-enabled device 1201 than when they are writing a scholarly treatise 1202 or other published literature.

One-on-one conversations between humans are qualitatively different in intent than AI bot dialog and small- or large group presentations. Bot-to-bot dialog must also be treated differently. The audience affects the interpretation of words.

When the audience is apparent from the metadata, 304 can be completed by extracting the information before interpreting the text. Determining an audience 304 in NLP involves using NLP techniques to analyze text data, such as keywords, sentiment, and topics to identify demographic data about the speaker or writer, psychographics, and behaviors indicated in the text.

The system can use source analysis to determine the characteristics of the target audience 1202 by determining if the interaction platform is e-mail, social media, published book, podcast or web page. The system uses topic analysis processes along with context to identify special interest groups 1203.

Both hostile and defensive language in the text 1204 can indicate hostility between the speaker and the audience. This is where determining the social connectedness or proximity between the speaker or writer and the audience 1205 becomes most important. Metadata about the text as well as relationship cues within the text can help determine proximity. The closer the audience is to the speaker or writer, the more charged choice of words becomes.

The next steps complete agenda analysis by determining intent to persuade, debate or counter-argue 1206 flagging internal dialog of introspection or self-abasement 1207 identifying neutral intentions to inform or inquire 1208 and non-neutral intent to judge, deceive, frighten, intimidate, self-serve or posture 1209. The system can also determine if the text is intended to comfort, reinforce, encourage or discourage 1210.

Process: As shown VIVA Analysis components include training data 104, a knowledge graph 108, model curation 105 and an evaluation layer 107 with local storage for efficiency 106. This system uses knowledge and meaning-based processes 107 instead of neural network pattern-based processes to analyze the intent of the input NL text: tasks that require deep understanding of semantics, context, logic and discourse pragmatics.

The algorithmic process begins with lexical disambiguation of the input 111 written or uttered natural language text 103. The lexical disambiguation process (as described in U.S. Pat. No. 7,403,890, Application No. 62/930,742 and application Ser. No. 19/214,139) stores clear contextual and conceptual meanings for each word, phrase and sentence in the input 111.

The meaning information, including contextual markers, as much as the input words 111, provide the basis for deeper understanding. Given the input text, the disambiguated contextual markers and conceptual meanings the process for the VIVA Analyses are as follows:

Build knowledge propositions in the knowledge fabric 504 for bias-indicative terms, their topics (arcs 701) as the contexts in which they apply, and the viewpoint 301 represented (i.e. where on the spectrum use of this term may fit).

The automated learning process 501 creates a contextualized representation. Supervised learning 502, model refinement and augmentation 503, and cyclical testing and deployment 505 506 complete the knowledge acquisition process.

The lexicon 415 is the set of words and short phrases composing the knowledge molecules and is independent of the model, but the model only includes knowledge propositions based on lexicon members. The knowledge propositions identify lexical objects with potential bias as analyzed by the processes above 301.

Both the Veracity 301 and Audience 304 processes use image analysis of the picture a speaker or writer paints through words. The tones, biases and intensity 302 of the word-image can tell us much about the speakers agenda vis-à-vis the audience.

VIVA Analysis leverages all types of knowledge propositions imported from the knowledge graph 108 to local memory 106 to populate the contextually 305 segregated attributes 306 with candidates 307. The candidates 307 are the possible answers to the questions of the attributes 306. Each candidate 307 is assigned 1301 to one or more attributes 306 and the genetic algorithm is applied to each attribute to see which candidate 307 emerges 1302 as the survivor or top weight 1303 candidate 308.

The genetic algorithm applies heuristic processes 1304 including mutation 1305 and crossover 1306 to the population of candidates to catalyze emergence 1302. Once a single candidate emerges 1303 it is added to the solution set and the system goes through the rest of the attributes 306 until each has a single emergent candidate 308.

Crossover 1306 applies the combined impact of two or more knowledge propositions to a single candidate 307 to raise or lower its weight. Mutation 1305 applies the independent impact of a single knowledge proposition to a single candidate 307 to raise or lower its weight. The solution set of surviving candidate 1307 knowledge propositions are the intended deep meaning of the input text 111.

Knowledge propositions 403 in the permanently stored knowledge graph 108 contain an a-priori confidence value 409. This value 409 serves as the basis or starting point 1401 on the emergence curve 1402 for each individual candidate 307 knowledge proposition 403 that is extracted from the knowledge graph 108 to assist in deep language understanding.

At each point in the process that the candidate 307 weight 409 or confidence value is inspected 1303, it may or may not have reached the maximum limit 1404 or threshold 1405 magnitude. The processes for adjusting the candidates' 307 weights 409 are described in U.S. Application No. 63/714,627.

The formula for inspecting candidates 1303 is

$$P ( x ) = \frac{L}{1 + {e}^{- k ( x - {x}_{0} ) 1}} ,$$

1501.
L serves as the limit of the growth in magnitude which the function cannot cross. The threshold T is a value less than L that is analogous to threshold potential in biological neuron firing which is a state that facilitates brain activity.

The mathematical point shown at x₀ 1403 is the inspection point in the context of the function. It can represent a change or inflection point in the growth rate k of the candidate's emergence function.

The vertical matrix 1503 Mₙₓ₁ is an n×1 matrix whose elements Pᵢ(x) represent the collective results of all the attributes 306 in all the context frames 305, or in other words, the inferred deep meaning of the input text 111. Test T 1503 determines if Pᵢ(x) is greater than some threshold T. Outputs 0 for failure and 1 for success.

The validation function F_{T}(M) 1504 applies the test T on each Pᵢ(x) in Mₙₓ₁ and outputs a vertical n×1 matrix. This validation uses commonsense knowledge as a “reality check” to ensure that each surviving candidate in each attribute correctly contributes to inferring the deep intent of the input text 111.

In some embodiments, the system can increase contextual information available for the analyses by using more than the input text 111:
Track dialogs across multiple give and take exchanges
Use system resources including the system clock and Global positioning system (GPS) to determine time and place and time of day
Use online information about the author/speaker to infer experiences and character traits that may affect meaning

While neural models use training formulas such as negative cross-entropy and Standard or Stochastic gradient descent to make up for the absence of explicit knowledge, our knowledge graph 108 with genetic algorithms are seven hundred fifty times more efficient in CPU and memory requirements in learning and correctly classifying new knowledge 504.

Humans learn by making associations between things, phenomena, people and ideas. Lexical and conceptual co-occurrence is the foundation of associative learning and is the foundation of the learning process for the lexical disambiguation system described above as the pre-requisite for VIVA Analysis processes. The result of these learning processes is a large knowledge model 105 that supports deep language understanding.

This is unlike Large Language Models (LLMs) used with Generative Pre-trained Transformers in that LLMs store patterns implicitly and our model stores explicit knowledge propositions in human readable format.

As such, the system is totally transparent, explainable, auditable. It also learns continually with no cutoff dates, and any knowledge in the system can be curated, corrected, tuned and rewritten if it is found to perpetuate biases that could be damaging.

Curation in Neural models often involves annotating source data prior to training. In this explicitly-stored knowledge model, knowledge propositions 403 that describe, for example, opinions directly related to specific topics form arcs 701 such that for each topic there can be a spectrum of opinion.

In many cases the center of the spectrum 701 may be considered a balanced 609 or even unbiased perspective or opinion. At certain points either direction from the center of the spectrum, the opinions may be marked as negative or harmful bias and associated with experienced injustice.

Much bias exists in literature 202 and public web 201 and social content 203, therefor this system for identifying and charting the magnitude of bias can be helpful in informing readers of biases with no value judgements of whether the biases are good or bad. When the biases are hidden and contain prejudicial stereotypes in the phrasing or assumptions, the user can make better informed decisions.

### INFORMATION DISCLOSURE STATEMENTS

U.S. Pat. No. 9,652,745B2: Model-driven evaluator bias detection—Describes methods and systems for detecting bias in human evaluators during assessment processes, such as reviewing digital interviews. It involves extracting candidate characteristics, classifying them, and determining if the evaluation data indicates an evaluator's bias with respect to those characteristics.

### Assignee: SHL ATITUDE, INC.

U.S. Pat. No. 11,068,797B2: Automatic correction of indirect bias in machine learning models—Focuses on detecting “hidden” or indirect bias in machine learning models during both training (design time) and operation (run time). The system identifies attributes like zip codes or addresses that might correlate with protected characteristics (e.g., income, language distribution) and cause indirect bias.

### Assignee: Accenture Global Solutions Limited

U.S. Pat. No. 11,551,102B2: Bias detection for unstructured text Focus: A patent for detecting bias within unstructured text data, a common issue when training natural language processing (NLP) models.
U.S. Pat. No. 11,886,321B2: System and method for bias evaluation scanning and maturity model Focus: Discloses a method for automatically identifying areas of potential bias within applications and systems by applying a machine learning model to intake data, and then implementing a mitigation process.

### Assignee: BANK OF AMERICA CORP.

U.S. Pat. No. 8,725,494: Entity-level Sentiment Analysis: A patent awarded to Attivio for big data sentiment analysis, focusing on determining the sentiment expressed about specific entities within large text datasets.
U.S. Pat. No. 9,208,502 B2: Sentiment analysis from multiple data sources: Describes a system for receiving data from multiple sources, including active audio or video communications, extracting keywords and analyzing contextual data to gauge sentiment, and then aggregating this information.
U.S. Pat. No. 11,256,874 B2: Sentiment progression analysis: This patent details methods for analyzing how sentiment changes over the course of a conversation, such as in a customer service call, by processing user utterances and applying a predictive model to score sentiment over time.
US 2025/0278571 A1: Fine-grained sentiment analysis using a hybrid model: A recent patent application that focuses on advanced hybrid models for more detailed and nuanced sentiment detection.
U.S. Pat. No. 8,838,438 B2 (System and method for determining sentiment from text content): This patent covers a method for determining sentiment values for a subject or specific categories based on the sentiment scores of salient terms extracted from user content.
US patent application U.S. Ser. No. 13/763,847 Interactive fact checking system The fact checking system automatically monitors, processes, fact checks information and indicates a status of the information.

### NON-PATENT CITATIONS (22)

1. Agarwal, O., Durupinar, F., Badler, N. I., & Nenkova, A. (2019). Word embeddings (also) encode human personality stereotypes. Proceedings of the Eighth Joint Conference on Lexical and Computational Semantics (*SEM 2019), 205-211. Minneapolis, Minnesota: Association for Computational Linguistics. https://www.aclweb.org/anthology/S19-1023
2. Asad, M., Dombrowski, L., Costanza-Chock, S., Erete, S., & Harrington, C. (2019). Academic accomplices: Practical strategies for research justice. Companion Publication of the 2019 on Designing Interactive Systems Conference 2019 Companion (pp. 353-356).
3. Bender, E. M., & Friedman, B. (2018). Data statements for natural language processing: Toward mitigating system bias and enabling better science. Transactions of the Association for Computational Linguistics, 6, 587-604. [Google Scholar]
4. Blodgett, S. L., Barocas, S., Daumé, H., III, & Wallach, H. (2020). Language (technology) is power: A critical survey of “bias” in NLP. Proceedings of the 58th Annual Meeting of the Association for Computational Linguistics, 5454-5476. Online: Association for Computational Linguistics. https://www.aclweb.org/anthology/2020.acl-main.485
5. Card, D., & Smith, N. A. (2020). On consequentialism and fairness. Frontiers in Artificial Intelligence, 3, 34. https://www.frontiersin.org/article/10.3389/frai.2020.00034 [DOI] [PMC free article] [PubMed] [Google Scholar]
6. Criado Perez, C. (2019). Invisible women: Exposing data bias in a world designed for men. Random House. [Google Scholar]
7. Dinan, E., Fan, A., Williams, A., Urbanek, J., Kiela, D., & Weston, J. (2020). Queens are powerful too: Mitigating gender bias in dialogue generation. Proceedings of the 2020 Conference on Empirical Methods in Natural Language Processing (EMNLP), 8173-8188. Online: Association for Computational Linguistics. https://www.aclweb.org/anthology/2020.emnlp-main.656
8. Dixon, L., Li, J., Sorensen, J., Thain, N., & Vasserman, L. (2018). Measuring and mitigating unintended bias in text classification. Proceedings of the 2018 AAAI/ACM Conference on AI, Ethics, and Society, AIES '18, 67-73. Association for Computing Machinery, New York, NY, USA. 10.1145/3278721.3278729 [DOI] 9. EU High-Level Expert Group on AI. (2019). Ethics guidelines for trustworthy AI. https://ec.europa.eu/newsroom/dae/document.cfm?doc_id=60419
10. Flek, L. (2020). Returning the N to NLP: Towards contextually personalized classification models. Proceedings of the 58th Annual Meeting of the Association for Computational Linguistics, 7828-7838. Online: Association for Computational Linguistics. https://www.aclweb.org/anthology/2020.acl-main.700
11. Friedler, S. A., Scheidegger, C., & Venkatasubramanian, S. (2021). The (im) possibility of fairness: Different value systems require different mechanisms for fair decision making. Communications of the ACM, 64, 136-143. [Google Scholar]
12. Fromreide, H., Hovy, D., & Søgaard, A. (2014). Crowdsourcing and annotating NER for Twitter #drift. Proceedings of the Ninth International Conference on Language Resources and Evaluation (LREC '14), 2544-2547. Reykjavik, Iceland: European Language Resources Association (ELRA). http://www.Irec-conf.org/proceedings/lrec2014/pdf/421_Paper.pdf
13. Garg, N., Schiebinger, L., Jurafsky, D., & Zou, J. (2018). Word embeddings quantify 100 years of gender and ethnic stereotypes. Proceedings of the National Academy of Sciences, 115, E3635-E3644. [DOI] [PMC free article] [PubMed][Google Scholar]
14. Hovy, D., & Yang, D. (2021). The importance of modeling social factors of language: Theory and practice. Proceedings of the 2021 Conference of the North American Chapter of the Association for Computational Linguistics: Human Language Technologies, 588-602. Online: Association for Computational Linguistics. https://www.aclweb.org/anthology/2021.naacl-main.49
15. Hutchinson, B., Smart, A., Hanna, A., Denton, E., Greer, C., Kjartansson, O., Barnes, P., & Mitchell, M. (2021). Towards accountability for machine learning datasets: Practices from software engineering and infrastructure. Proceedings of the 2021 ACM Conference on Fairness, Accountability, and Transparency, 560-575.
16. Joshi, P., Santy, S., Budhiraja, A., Bali, K., & Choudhury, M. (2020). The state and fate of linguistic diversity and inclusion in the NLP world. Proceedings of the 58th Annual Meeting of the Association for Computational Linguistics, 6282-6293. Online: Association for Computational Linguistics. https://www.aclweb.org/anthology/2020.acl-main.560
17 Kennedy, B., Jin, X., Mostafazadeh Davani, A., Dehghani, M., & Ren, X. (2020). Contextualizing hate speech classifiers with post-hoc explanation. Proceedings of the 58th Annual Meeting of the Association for Computational Linguistics, 5435-5442. Online: Association for Computational Linguistics. https://www.aclweb.org/anthology/2020.acl-main.483
18. Kurita, K., Vyas, N., Pareek, A., Black, A. W., & Tsvetkov, Y. (2019). Measuring bias in contextualized word representations. Proceedings of the First Workshop on Gender Bias in Natural Language Processing, 166-172. Florence, Italy: Association for Computational Linguistics. https://www.aclweb.org/anthology/W19-3823
19. Nozza, D., Bianchi, F. and Hovy, D. (2021). Measuring hurtful sentence completion in language models. Proceedings of the 2021 Conference of the North American Chapter of the Association for Computational Linguistics: Human Language Technologies, 2398-2406. Online: Association for Computational Linguistics. https://www.aclweb.org/anthology/2021.naacl-main. 191
20. Saunders, D., & Byrne, B. (2020). Reducing gender bias in neural machine translation as a domain adaptation problem. Proceedings of the 58th Annual Meeting of the Association for Computational Linguistics, 7724-7736. Online: Association for Computational Linguistics. https://www.aclweb.org/anthology/2020.acl-main.690
21. Zhao, J., Wang, T., Yatskar, M., Cotterell, R., Ordonez, V., & Chang, K.-W. (2019). Gender bias in contextualized word embeddings. Proceedings of the 2019 Conference of the North American Chapter of the Association for Computational Linguistics: Human Language Technologies, Volume 1 (Long and Short Papers), 629-634. Minneapolis, Minnesota: Association for Computational Linguistics. https://www.aclweb.org/anthology/N19-1064
22. Zhao, J., Wang, T., Yatskar, M., Ordonez, V., & Chang, K.-W. (2017). Men also like shopping: Reducing gender bias amplification using corpus-level constraints. Proceedings of the 2017 Conference on Empirical Methods in Natural Language Processing, 2979-2989. Copenhagen, Denmark: Association for Computational Linguistics. https://www.aclweb.org/anthology/D17-1323

What is claimed:

1. A method comprising:
receiving, at a deep language understanding module of an interpreter running on a computing device, preprocessed natural language text having completed lexical disambiguation processes revealing the broad interpretation of the meaning, to analyze and detect the viewpoint, intensity, veracity and audience of the text to better understand the author's or speaker's intent using commonsense knowledge in an explicit knowledge graph with genetic algorithms simulating cognitive emergence, the processes comprising:
retrieving knowledge propositions for deep meaning analysis from a knowledge graph based on direct associations with the input text;
classifying the deep meaning knowledge propositions in named attributes in named context frames for analysis;
analyzing viewpoint and bias based on word placement on topic-based opinion arcs;
analyzing intensity and exaggeration based on quantitative and qualitative statements vis-à-vis normative descriptions;
analyzing veracity and agenda by identifying fictitious statements and biased assertions;
analyzing audience and social proximity by extracting as much profile information as is available about the context in which the text was created, its audience and author.

2. A method comprising:
combining input text and commonsense knowledge in a plurality of context frames in which questions needing answers within each frame are defined as attributes named with human language words and in which each attribute may be populated with any number of candidate answers defined as human language words or phrases tied to specific knowledge propositions to answer the question represented by the attribute with a process to:
apply heuristic procedures to increase or decrease the probability value or weight associated with each candidate until one or more candidates reach a threshold value defined as the emergence level;
apply logical reasoning with commonsense knowledge to determine the intended meaning of the speaker or writer and the accuracy and objectivity of the text; and
use genetic algorithms to apply crossover and mutation inputs to the heuristics to contribute to increasing and decreasing the confidence values to accelerate candidate differentiation toward the threshold value.

3. A method comprising:
applying crossover and mutation heuristic processes to sort the candidate knowledge propositions in each of a plurality of defined attributes each in a defined context frame to infer discreet elements of intent with a process to:
identify emergent or top scoring candidates as surviving individuals in each population; and
validate the correctness of the inferred association with the input text.

4. A continuous learning system in which digital content of any format is presented to a machine learning algorithm that reads natural language text in the digital content, disambiguates it's meaning, and infers knowledge propositions reflecting the digital contents, searches the knowledge graph for previously learned knowledge propositions matching the inferred knowledge propositions, and in the case of no matches, adds the newly inferred knowledge propositions to a queue for validation and potential addition to the core knowledge graph.

5. A validation support process in which the continuous learning system analyzes each newly inferred knowledge proposition in a validation queue by searching any accessible digital content for corroborating evidence.
